(19) United States
(12) Patent Application Publication
(10) Pub. No.: US 2026/0220986 A1
(43) Pub. Date: Jul. 30, 2026

(54) BACKUP POWER SUPPLY SYSTEM, MOVING BODY, POWER SUPPLY BACKUP METHOD, AND PROGRAM

(71) Applicant: Panasonic Intellectual Property Management Co., Ltd., Osaka (JP)

(72) Inventors: YASUHIRO IIJIMA, Osaka (JP); SHOHEI YAMANAKA, Osaka (JP)

(21) Appl. No.: 19/146,969

(22) PCT Filed: Nov. 8, 2023
(86) PCT No.: PCT/JP2023/040233

§ 371 Date: Jul. 10, 2025

(30) Foreign Application Priority Data
Mar. 23, 2023 (JP) 2023-047325

(51) Int. Cl. G07C 5/08; B60R 16/03; H02J 9/06

(52) U.S. Cl. CPC G07C 5/0808; B60R 16/03; H02J 9/06

(57) ABSTRACT

A backup power supply system includes a detector, a power storage unit, a connection circuit, and a controller. The detector is configured to detect a failure of a power supply that supplies electric power to a load. The connection circuit connects the power storage unit to the load to supply electric power from the power storage unit to the load if the detector detects the failure of the power supply. The controller is configured to receive the electric power supplied from the power storage unit and perform an intermittent operation in which the controller repeats starting and stopping alternately if the detector detects the failure of the power supply.

### TECHNICAL FIELD

The present disclosure generally relates to a backup power supply system, a movable body, a power supply backup method, and a program. More particularly, the present disclosure relates to a backup power system for supplying electric power from a power storage unit to a load at a failure of a power supply, a movable body including the backup power supply system, a power supply backup method, and a program.

### BACKGROUND ART

A power source device for vehicle (backup power supply system) disclosed in PTL 1 includes an electronic controller (load), a battery (power supply), and a capacitor unit (power storage unit). The battery supplies electric power to the electronic controller. The capacitor unit functions as an auxiliary power supply and is connected between the battery and the electronic controller to supply electric power to the electronic controller if any abnormality (failure) occurs in the battery.

### CITATION LIST

### Patent Literature

PTL 1: Japanese Patent Laid-Open Publication No. 2005-14754

### SUMMARY OF INVENTION

In a power source device for vehicles disclosed in PTL 1, a backup duration at a failure of a power supply (duration of supplying electric power from a power storage unit to a load) is determined by the capacity of the power storage unit.

However, although the capacity of the power storage unit is designed to satisfy the backup duration that the load requires, a failure may occur in the power supply if the power storage unit is not fully charged. Therefore, depending on the charging state of the power storage unit, the backup duration may be insufficient with respect to the backup duration required by the load.

A backup power supply system according to an aspect of the present disclosure includes a detector, a power storage unit, a connection circuit, and a controller. The detector is configured to detect a failure of a power supply that supplies electric power to a load. The power storage unit is a power storage unit for backup of the power supply. The connection circuit is configured to connect the power storage unit to the load if the detector detects the failure of the power supply to supply electric power from the power storage unit to the load. If the detector detects the failure of the power supply, the controller is configured to receive electric power supplied from the power storage unit to perform an intermittent operation in which the controller repeats starting and stopping alternately.

A movable body according to an aspect of the present disclosure includes the backup power supply system. The movable body includes a main body, the load, and the backup power supply system. The load is provided in the main unit. The backup power supply system is provided in the main body.

A power supply backup method according to one aspect of the present disclosure includes detection, connection, and control processes. In the detection process, a failure of the power supply that supplies electric power to the load is detected. In the connection process, the power storage unit for backup of the power supply is connected to the load to supply electric power from the power storage unit to the load if a failure of the power supply is detected in the detection process. In the control process, the controller that receives electric power supplied from the power storage unit performs an intermittent operation in which the controller repeats starting and stopping alternately if the failure of the power supply is detected in the detection process.

A program according to an aspect of the present disclosure causes a computer system to execute the power supply backup method.

The backup power supply system, the movable body, the power supply backup method, and the program according to the present disclosure extends a backup duration.

### BRIEF DESCRIPTION OF DRAWINGS

FIG. 1 is a schematic diagram of a backup power supply system according to a first exemplary embodiment.

FIG. 2 is a partial perspective side view of a vehicle including the backup power supply system according to the first embodiment.

FIG. 3 is a comparison chart illustrating comparison of waveforms of an output voltage from a power storage unit between the backup power supply system according to the first embodiment and a comparative example.

FIG. 4 is a flow chart illustrating an operation of the backup power supply system according to the first embodiment.

FIG. 5 is a flow chart illustrating details of processes in Steps S8 and S9 shown in FIG. 4.

FIG. 6 is a flow chart illustrating an operation of a backup power supply system according to a second exemplary embodiment.

FIG. 7 is a flow chart illustrating an operation of a backup power supply system according to a third exemplary embodiment.

FIG. 8 is a flow chart illustrating an operation of a backup power supply system according to a fourth exemplary embodiment.

### DESCRIPTION OF EMBODIMENT

A backup power supply system according to exemplary embodiments of the present disclosure will be described below. The exemplary embodiments below are merely examples of various exemplary embodiments of the present disclosure. Still more, various modifications according to design or the like are applicable to the exemplary embodiments below as long as the purpose of the present disclosure is achieved.

### (1) FIRST EXEMPLARY EMBODIMENT

### (1-1) Outline

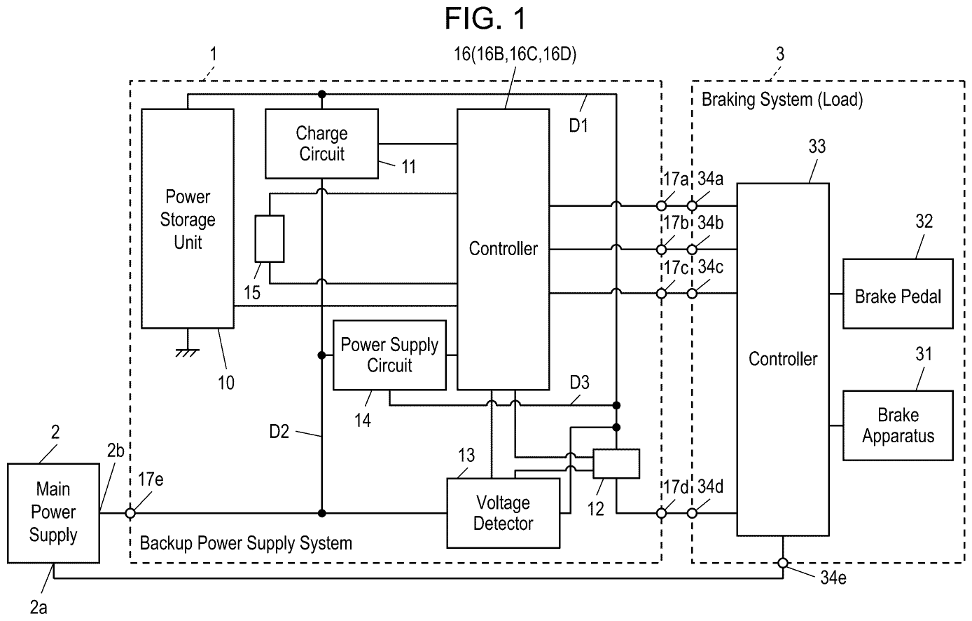

An outline of backup power supply system 1 according to a first exemplary embodiment will be described with reference to FIG. 1.

As illustrated in FIG. 1, backup power supply system 1 stores electric power from main power supply 2 in power storage unit 10 in backup powers supply system 1 if main power supply 2 does not have a failure (i.e., main power supply 2 is normal). If main power supply 2 has a failure, backup power supply system 1 supplies, instead of main power supply 2, electric power stored in power storage unit 10 to load 3. Therefore, even if main power supply 2 has a failure, load 3 continuously operates with electric power supplied from power storage unit 10 of backup power supply system 1. The failure of main power supply 2 refers to a decrease of an output voltage of main power supply 2 to a voltage lower than a threshold voltage due to a breakdown, deterioration, or disconnection of main power supply 2 (in order words, stop of power supply from main power supply 2 to load 3).

Backup power supply system 1 includes voltage detection circuit 13 (detector), power storage unit 10, connection circuit 12, and controller 16. Voltage detection circuit 13 is configured to detect a failure of main power supply 2 (power source) that supplies electric power to load 3. Power storage unit 10 is a backup power storage unit for main power supply 2. Connection circuit 12 is configured to connect load 3 to power storage unit 10 if voltage detection circuit 13 detects a failure of main power supply 2 so as to supply electric power from power storage unit 10 to load 3. Controller 16 is configured to receive electric power supplied from power storage unit 10 if voltage detection circuit 13 detects the failure of main power supply 2, and performs an intermittent operation in which controller 13 repeats starting and stopping alternately.

In the above configuration, the intermittent operation by controller 16 at the failure of main power supply 2 suppresses power consumption by controller 16 at the failure of main power supply 2. This configuration extends the duration of supplying electric power from power storage unit 10 to load (backup duration).

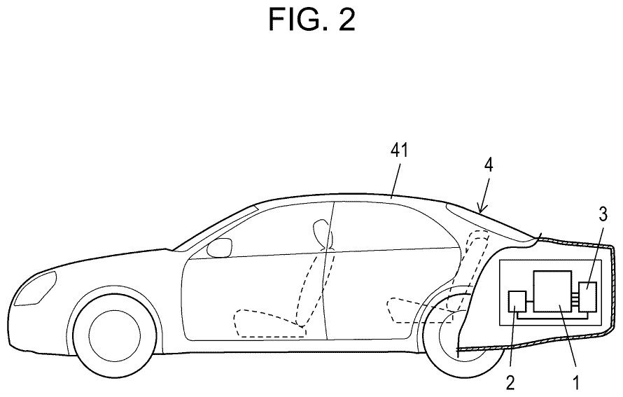

Backup power supply system 1 is, for example, installed to vehicle 4 (e.g., automobile) (FIG. 2). Backup power supply system 1 is, for example, a backup power supply system for a brake system of vehicle 4. In other words, backup power supply system 1 supplies electric power to the brake system as load 3 if main power supply 2 has a failure.

Backup power supply system 1 is not necessarily the backup power supply for brake system, and may be a backup power supply system for automotive equipment (e.g., shift-by-wire system) other than the brake system installed to vehicle 4.

Vehicle 4 (movable body) includes vehicle body 41 (main body), main power supply 2, load 3, and backup power supply system 1.

Main power supply 2 is a battery (e.g., lead storage battery) installed to vehicle 4, and is configured to supply electric power to load 3 and backup power supply system 1. Main power supply 2 includes, for example, two output terminals 2a and 2b for outputting an output voltage of main power supply 2. Output terminal 2a is connected to external terminal 34e, described later, of load 3. Output terminal 2b is connected to external terminal 17e, described later, of backup power supply system 1.

Load 3 is an automotive device configured to operate with electric power supplied from main power supply 2. For example, load 3 is a brake system. Hereinafter, load 3 may be referred to as brake system 3. Brake system 3 is configured to control a braking force of a brake apparatus configured to brake the rotation of wheels of vehicle 4 according to a position of a brake pedal of vehicle 4.

As described above, backup power supply system 1 is configured to charge power storage unit 10 with electric power from main power supply 2 if main power supply 2 has a failure, and to supply electric power from power storage unit 10 to load 3 if main power supply 2 has a failure.

### (1-2) Configuration of Brake System

A configuration of brake system 3 will be described with reference to FIG. 1. As illustrated in FIG. 1, brake system 3 includes brake device 31, brake pedal 32, controller 33, and external terminals 34a to 34e.

External terminals 34a to 34e are connected to external terminals 17a to 17d of brake system 3 and output terminal 2a of main power supply 2. External terminals 34a to 34c are connected to external terminals 17a to 17c of backup power supply system 1, respectively, and are used for communication between controller 16 of backup power supply system 1 and controller 33 of brake system 3. External terminal 34d is connected to external terminal 17d of backup power supply system 1, so that electric power from power storage unit 10 of backup power supply system 1 is input if main power supply 2 has a failure. External terminal 34e is connected to main power supply 2, so that electric power from main power supply 2 is input to external terminal 34e.

Brake device 31 is configured to brake the rotation of wheels of vehicle 4 under the control by controller 33.

Brake pedal 32 is an operation device configured to receive an operation on brake device 31 performed by a foot of a driver.

Controller 33 is configured to operate with electric power supplied from main power supply 2 and power storage unit 10 of backup power supply system 1. More specifically, if main power supply 2 does not have a failure, controller 33 operates with electric power supplied from main power supply 2 via external terminal 34e. If main power supply 2 has a failure, controller 33 operates with electric power supplied from power storage unit 10 of backup power supply system 1 via external terminal 34d.

Controller 33 is configured to control a braking force of brake device 31 according to the position of brake pedal 32. More specifically, controller 33 detects the position of brake pedal 32, generates a control signal according to the detected position, and outputs the generated control signal to brake device 31 to control the braking force of brake device 31.

Controller 33 is configured to communicate with controller 16 of backup power supply system 1. Controller 33 is configured to control a startup of controller 16 by transmitting a start signal to controller 16 of backup power supply system 1 via external terminal 34a.

Controller 33 is configured to transmit and receive various signals to and from backup power supply system 1 via external terminals 34b and 34c. For example, controller 33 receives, from backup power supply system 1 via external terminals 34b and 34c, signals notifying that main power supply 2 has a failure (or power supply from power storage unit 10 has started), and controller 16 of backup power supply system 1 starts the intermittent operation.

For example, controller 33 is implemented mainly by a computer including a central processing unit (CPU) and a memory. Various functions of controller 33 are implemented by causing the CPU execute programs stored in a memory. The programs may be previously recorded in the memory of the computer, provided by a recording medium, such as a memory card recording the programs therein, or provided via an electric communication line, such as the Internet.

### (1-3) Configuration of Backup Power Supply System

A configuration of backup power supply system 1 will be described with reference to FIG. 1. As illustrated in FIG. 1, backup power supply system 1 includes power storage unit 10, charge circuit 11, connection circuit 12, voltage detection circuit 13, power supply circuit 14, temperature measurement unit 15, controller 16, and external terminals 17a to 17e. Components other than power storage unit 10, connection circuit 12, voltage detection circuit 13, and controller 16 are not essential to the configuration of the present disclosure.

External terminals 17a to 17e are connected to external terminals 34a to 34d of brake system 3 and output terminal 2b of main power supply 2. More specifically, external terminals 17a to 17c are connected to external terminals 34a to 34c of brake system 3, respectively, and are used for communication between controller 16 of backup power supply system 1 and controller 33 of brake system 3. External terminal 34e is connected to external terminal 34d of brake system so as to output electric power from power storage unit of backup power supply system 1 to brake system 3. External terminal 17d is connected to output terminal 2b of main power supply 2 so as to input electric power from main power supply 2.

Power storage unit 10 is, for example, an electrical double layer capacitor (EDLC). Power storage unit 10 is connected to external terminal 17d via electric path D1. Connection circuit 12 is provided in electric path D1. Power storage unit 10 outputs electric power stored (charged) in power storage unit 10 to brake system 3 according to electrical connection and disconnection of connection circuit 12 described later. Power storage unit 10 is connected to external terminal 17e via electric path D2. Charge circuit 11 is provided in electric path D2. Power storage unit 10 is charged with electric power supplied from main power supply 2 via charge circuit 11.

If main power supply 2 does not have a failure, charge circuit 11 charges power storage unit 10 with electric power supplied from main power supply 2 connected to external terminal 17e under the control by controller 16. Charge circuit 11 is provided in electric path D2 connecting main power supply 2 to external terminal 17e. Charge circuit 11 is, for example, a buck converter including semiconductor switches. Charge circuit 11 charges power storage unit 10 by changing (e.g., stepping down) an output voltage of main power supply 2 and outputting the changed output voltage to power storage unit 10.

Connection circuit 12 electrically connects and disconnects electric path D1 connecting power storage unit 10 to external terminal 17d under the control by voltage detection circuit 13 or the control by controller 16, whichever is earlier. For example, connection circuit 12 includes a semiconductor switch for electrically connecting and disconnecting electric path D1. If main power supply 2 has a failure, connection circuit 12 connects electric path D1 under the control by voltage detection circuit 13 or controller 16, whichever is earlier, thereby supplying electric power from power storage unit 10 to brake system 3 connected to external terminal 17d. If main power supply 2 recovers from the failure, connection circuit 12 disconnects electric path D1 under the control by controller 16, thereby stopping the supply from power storage unit 10 to brake system 3.

Voltage detection circuit 13 controls electrical connection and disconnection of connection circuit 12 based on the output voltage of main power supply 2. More specifically, voltage detection circuit 13 detects the output voltage of main power supply 2 based on a voltage of external terminal 172. Voltage detection circuit 13 detects a failure of main power supply 2 based on the output voltage of main power supply 2. More specifically, if the output voltage of main power supply 2 is higher than or equal to a threshold voltage, voltage detection circuit 13 determines that main power supply 2 does not have a failure (i.e., not detecting a failure of main power supply 2). If the output voltage of main power supply 2 is lower than the threshold voltage, voltage detection circuit 13 determines that main power supply 2 has a failure (i.e., detecting a failure of main power supply 2). Then, if no failure of main power supply 2 is detected, voltage detection circuit 13 controls connection circuit 12 to disconnect electric path D1. If a failure of main power supply 2 is detected, voltage detection circuit 13 controls connection circuit 12 to connect electric path D1.

Power supply circuit 14 generates an operating voltage (e.g., 5 V) of controller 16. Power supply circuit 14 is connected between a power supply input of controller 16 and external terminal 17e. Thus, power supply circuit 14 generates the operating voltage from the output voltage of main power supply 2 connected to external terminal 17e if main power supply 2 does not have a failure, and the operating voltage generated is supplied to controller 16. In other words, power supply circuit 14 is configured to change and supply electric power supplied from main power supply 2 to controller 16. Power supply circuit 14 is connected to power storage unit 10 via electric path D3. Thus, if main power supply 2 has a failure, power supply circuit 14 generates the operating voltage from the output voltage of power storage unit 10, and supplies the operating voltage generated to controller 16. In other words, power supply circuit 14 convert and supplies electric power supplied from power storage unit 10 to controller 16.

Temperature measurement unit 15 is disposed near power storage unit 10, and configured to measure a temperature of power storage unit 10. Temperature measurement unit 15 is implemented by, for example, a thermistor.

For example, controller 16 is implemented mainly by a computer including a central processing unit (CPU) and a memory. Various functions of controller 16 are implemented by causing the CPU execute programs stored in the memory. The programs may be previously recorded in the memory of the computer, provided by a recording medium, such as a memory card recording the program therein, or provided via an electric communication line, such as the Internet.

If main power supply 2 does not have a failure, controller 16 operates with electric power supplied from main power supply 2 via power supply circuit 14. If main power supply 2 has a failure, controller 16 operates with electric power supplied from power storage unit 10 via power supply circuit 14.

If controller 16 receives, via external terminal 17a, a start signal from controller 33 of brake system 3, controller 16 starts upon receiving power supply from power supply circuit 14.

Controller 16 performs a failure determination process, a recovery determination process, a transmission and reception process, and a monitoring process, which will be described later.

As the failure determination process, controller 16 determines, based on a voltage of external terminal 17e (i.e., output voltage of main power supply 2), whether or not main power supply 2 has a failure. If controller 16 determines that main power supply 2 has a failure, controller 16 controls connection circuit 16 to connect electric path D1. Thus, electric power stored in power storage unit 10 is supplied via electric path D1 to brake system 3 connected to external terminal 17d if main power supply 2 has the failure. If controller 16 determines that main power supply 2 does not have a failure, controller 16 controls connection circuit 12 to disconnect electric path D1. Thus, power supply from power storage unit 10 to brake system 3 via electric path D1 is stopped if main power supply 2 does not have a failure.

In the above failure determination process, determination of a failure of main power supply 2 may be regarded as detection of the failure of main power supply 2, and determination of no failure in main power supply 2 may be regarded as no detection of failure in main power supply 2. Therefore, the above failure determination process is equivalent to a detector that detects a failure of main power supply 2.

In accordance with the first embodiment, two detectors (voltage detection circuit 13 and failure determination process by controller 16) includes detecting a failure of main power supply 2. Voltage detection circuit 13 is implemented by a circuit, and the failure determination process is realized by software processing. A voltage detection circuit configured with a circuit is configured to detect a failure of main power supply 2 earlier than the failure determination process implemented by software processing.

As the aforementioned recovery determination process, controller 16 determines, based on the voltage of external terminal 17e (i.e., output voltage of main power supply 2), whether or not main power supply 2 has recovered from the failure. More specifically, controller 16 determines whether or not the voltage of external terminal 17e is continuously higher than or equal to a recovery voltage for a threshold duration (e.g., 2 seconds). Controller 16 determines that main power supply 2 has recovered if the voltage of external terminal 17e is continuously higher than or equal to the recovery voltage for the threshold duration. Controller 16 determines that main power supply 2 has not recovered if the voltage of external terminal 17e is not continuously higher than or equal to the recovery voltage for the threshold duration. If controller 16 determines that main power supply 2 has recovered, controller 16 controls connection circuit 12 to disconnect electric path D1. Thus, power supply from power storage unit 10 to brake system 3 via electric path D1 is stopped if main power supply 2 is recovered. If controller 16 determines that main power supply 12 has not recovered, controller 16 controls connection circuit 12 to electrically connect electric path D1. Thus, power supply from power storage unit 10 to brake system 3 via electric path D1 continues if main power supply 2 is not recovered.

As the aforementioned transmission and reception process, controller 16 transmits and receives signals to and from controller 33 of brake system 3 via external terminals 17a to 17c. For example, controller 16 receives signals (e.g., start signal) from controller 33 of brake system 3 via external terminals 17a to 17c.

As the aforementioned monitoring process, controller 16 monitors circuits (charge circuit 11, connection circuit 12, voltage detection circuit 13, power supply circuit 14, temperature measurement unit 15, and controller 16) in backup power supply system 1 for any abnormality (i.e., normal operation or not).

If controller 16 determines that main power supply 2 does not have a failure in the failure determination process, controller 16 performs a normal operation. If controller 16 determines that main power supply 2 has a failure in the failure determination process, controller 16 stops the normal operation and performs the intermittent operation. In accordance with the first embodiment, if controller 16 determines that main power supply 2 has a failure, controller 16 continuously performs the intermittent operation in a period from the determination to recovery of main power supply 2. If controller 16 determines that main power supply 2 has recovered, controller 16 stops the intermittent operation and performs the normal operation.

In the normal operation, controller 16 performs the failure determination process, the monitoring process, and the transmission and reception process.

In the intermittent operation, controller 16 repeats starting and stopping alternately. More specifically, controller 16 repeats a cycle of starting up, operating for a predetermined period, stopping, and restarting after a predetermined period. The stopping in the intermittent operation is a sleep state of temporarily stopping controller 16. If controller 16 determines that main power supply 2 has a failure, controller 16 autonomously performs the intermittent operation. In the intermittent operation, the transmission and reception process and the recovery determination process are performed while controller 16 starts and operates. During the intermittent operation, controller 16 thus performs only part of the processes in the normal operation. As a result, power consumption of controller 16 is suppressed by reducing the amount of processing, compared with the normal operation. If controller 16 determines that main power supply 2 has recovered in the above failure determination process, controller 16 is switched from the intermittent operation to the normal operation. The intermittent operation is continuously performed if main power supply 2 has a voltage lower than the recovery voltage during the intermittent operation.

According to the first exemplary embodiment, power consumption of controller 16 during a failure of main power supply 2 is suppressed due to the intermittent operation of controller 16 during the failure of main power supply 2. Accordingly, consumption of electric power stored in power storage unit is reduced during the failure of main power supply 2. As a result, during the failure of main power supply 2, a duration of supplying electric power (backup duration) from power storage unit 10 to brake system 3 is extended.

### (1-4) Comparison of Waveforms of Output Voltage of Power Storage Unit

Waveforms of the output voltage of power storage unit 10 during the failure of main power supply 2 will be compared between the first exemplary embodiment and Comparative Example.

In accordance with the first embodiment, consumption of electric power stored in power storage unit 10 is suppressed by the intermittent operation of controller 16 during the failure of main power supply 2. Comparative Example is different from the first exemplary embodiment in that controller 16 does not perform the intermittent operation (i.e., performs an operation identical to the normal operation) during the failure of main power supply 2, but others are similarly configured. In the comparison, waveforms of the output voltage of power storage unit 10 are compared if brake device 31 is activated with brake pedal 32 stepped on twice.

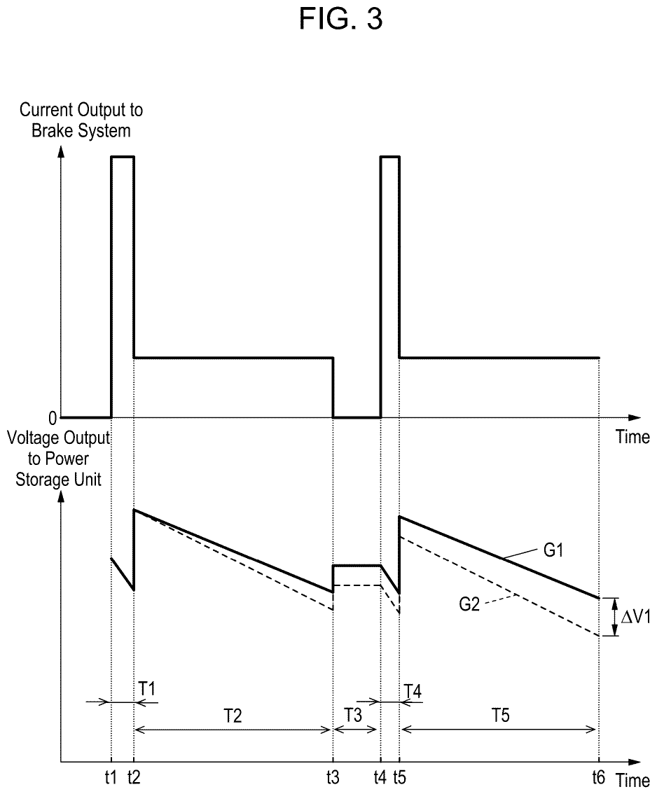

The upper graph of FIG. 3 is a waveform of current output from power storage unit 10 to brake system 3 (hereinafter simply referred to as “current”) when brake pedal 32 is stepped on twice. The lower graph of FIG. 3 is a waveform of the output voltage of power storage unit 10 when brake pedal 32 is stepped on twice (i.e., when current in the upper graph of FIG. 3 flows). In the lower graph of FIG. 3, profile G1 represents the output voltage according to the first exemplary embodiment, and profile G2 represents the output voltage according to Comparative Example.

In FIG. 3, brake pedal 32 is temporarily stepped on at time points t1 and t4. When brake pedal 32 is stepped on (time points t1 and t4), brake device 31 operates and consumes electric power. Therefore, the current of power storage unit 10 rapidly increases temporarily when brake pedal 32 is stepped on. Then, the current of power storage unit 10 rapidly decreases when brake pedal 32 is released (time points t2 and t5) after a predetermined time (time T1 between time points t1 and t2 and time T4 between time points t4 and t5) elapses. Then, after a constant small current flows for a predetermined time (for time T2 between time points t2 and t3 and for time T5 between time points t5 and t6), the current of power storage unit 10 returns to the original current.

In accordance with both the first exemplary embodiment and Comparative Example, the output voltage of power storage unit 10 decreases at a constant rate as a constant amount of the current of power storage unit 10 flows in time T1 between time points t1 and t2 and in time T4 between time points t4 and t5. Then, at time points t2 and t5, the output voltage rapidly increases as the current rapidly decreases. In accordance with both the first exemplary embodiment and Comparative Example, the output voltage of power storage unit 10 decreases at a constant rate as a constant amount of the current of power storage unit 10 flows in time T2 between time points t2 and t3 and in time T5 between time points t5 and t6. Then, in accordance with both the first exemplary embodiment and Comparative Example, the output voltage of power storage unit 10 rapidly increases at time point t3 as the current of power storage unit 10 rapidly decreases, and the output voltage becomes constant in time T3 between time points t3 and t4 when the current becomes zero.

The output voltage of power storage unit 10 decreases (i.e., gentle slope) during time T2 between time points t2 and t3 and during time T5 between time points t5 and t6 in the first exemplary embodiment (profile G1) more gently (i.e., at a gentler slope) than that of Comparative Example (profile G2). In other words, since the power consumption of controller 16 is reduced by the intermittent operation of controller 16 in accordance with the first exemplary embodiment, consumption of electric power stored in power storage unit 10 is suppressed. Thus, a rate of decrease in the output voltage of power storage unit 10 is smaller (i.e., a gentler slope in the profile) than that of Comparative Example in which controller 16 does not perform the intermittent operation. Accordingly, the output voltage of power storage unit 10 is higher in the first exemplary embodiment than Comparative Example by voltage difference ΔV1 from a voltage at time point t1 at which brake pedal 2 is stepped on to a voltage at time point t6 after a predetermined time has elapsed. In other words, the first exemplary embodiment has more remaining electric power in power storage unit 10 than Comparative Example. Thus, the backup duration of power storage unit 10 is extended in the first exemplary embodiment more than in Comparative Example.

### (1-5) Operation

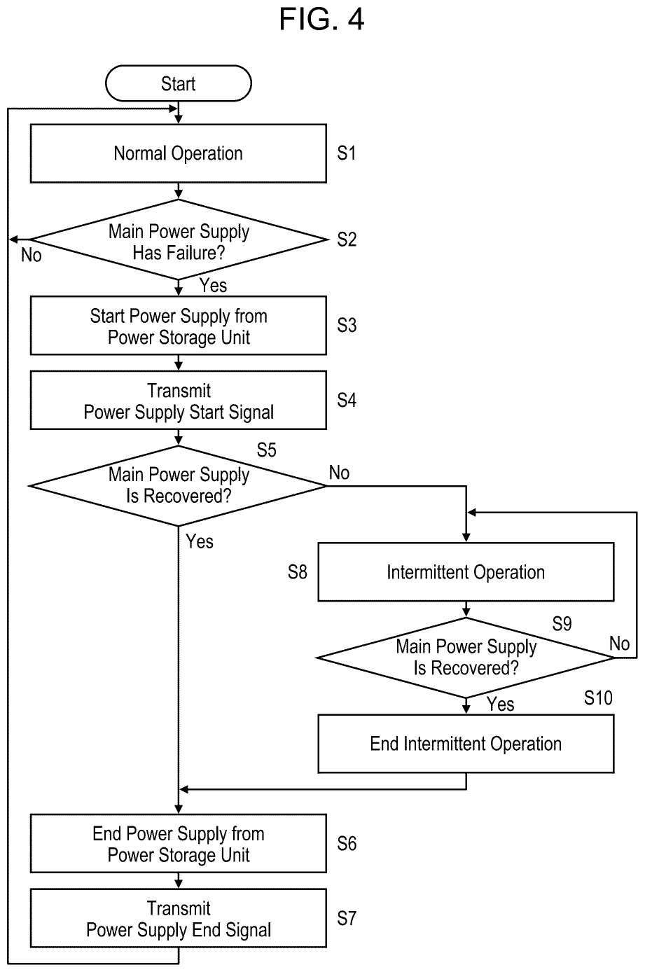

An operation of backup power supply system 1 will be described with reference to FIG. 4.

Controller 16 of backup power supply system 1 receives electric power supplied from main power supply 2 via power supply circuit 14 to perform the normal operation (Step S1). In the description of operation below, it is assumed that main power supply 2 does not have a failure at starting the operation of controller 16. Therefore, controller 16 receives electric power supplied from main power supply 2 via power supply circuit 14 to perform the normal operation at the start of the operation as illustrated in Step S1.

Then, controller 16 and voltage detection circuit 13 separately determine whether main power supply 2 has a failure or not (Step S2). It is assumed that controller 16 and voltage detection circuit 13 reach the same determination result although timings of reaching the determination result are different. According to the determination results, if main power supply 2 does not have a failure (Step S2: No), the process returns to Step S1. Then, Steps S1 and S2 are repeated.

On the other hand, according to the determination results in Step S2, if main power supply 2 has a failure (Step S2: Yes), controller 16 and voltage detection circuit 13 separately control connection circuit 12 to electrically connect electric path D1. Connection circuit 12 connects electric path D1 according to the control of controller 16 or voltage detection circuit 13, whichever is earlier. This connection starts supplying power from power storage unit 10 to brake system 3 connected to external terminal 17d via electric path D1 (Step S3). Then, if power supply from power storage unit 10 to brake system 3 starts, controller 16 transmits a power supply start signal from external terminal 17c to controller 33 of brake system 3 (Step S4). The power supply start signal is a signal to notify that power supply from power storage unit 10 to brake system 3 has started (i.e., backup power supply system 1 is switched to a backup mode).

Then, controller 16 determines whether main power supply 2 has recovered from the failure or not (Step S5). More specifically, controller 16 determines whether the voltage of external terminal 17e (i.e., output voltage of main power supply 2) is continuously higher than or equal to the recovery voltage for the threshold duration (e.g., 2 seconds). If main power supply 2 has recovered according to this determination result (Step S5: Yes), controller 16 controls connection circuit 12 to disconnect electric path D1. Connection circuit 12 disconnects electric path D1 according to the control by controller 16. As a result, power supply from power storage unit 10 to brake system 3 ends (Step S6). After recovery of main power supply 2, controller 16 and brake system 3 operate by receiving electric power from main power supply 2. If power supply from power storage unit 10 to brake system 3 ends, controller 16 transmits a power supply end signal from external terminal 17c to controller 33 of brake system 3 (Step S7). The power supply end signal is a signal that notifies termination of power supply from power storage unit 10 to brake system 3 (i.e., backup power supply 1 has returned to a normal mode). Then, the process returns to Step S1.

On the other hand, if main power supply 2 has not recovered according to the determination result in Step S5 (Step S5: No), controller 16 receives electric power from power storage unit 10 via power supply circuit 14, and performs the intermittent operation (Step S8). Then, controller 16 determines whether main power supply 2 has recovered from the failure or not (Step S9). If main power supply 2 has not recovered from the failure according to this determination result (Step S9: No), the process returns to Step S8, and controller 16 continuously performs the intermittent operation. On the other hand, if main power supply 2 has recovered from the failure according to the determination in Step S9 (Step S9: Yes), controller 16 ends the intermittent operation (Step S10). Then, the process proceeds to Step S6, and processes on and after Step S6 are performed.

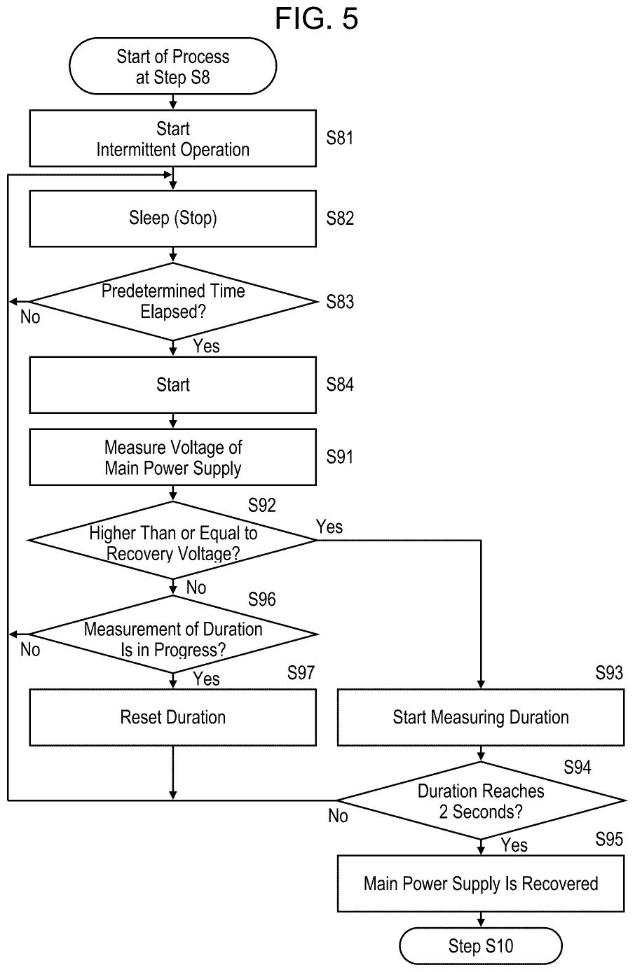

Next, Steps S8 and S9 shown in FIG. 4 will be detailed with reference to FIG. 5.

In Step S8, controller 16 of backup power supply system 1 starts the intermittent operation (Step S81). Upon starting the intermittent operation, controller 16 enters into a sleep state (stop state) (Step S82). Then, controller 16 determines whether or not a predetermined time has elapsed from a time point of entering the sleep state (Step S83). According to this determination result, if the predetermined time has not elapsed (Step S83: No), the process returns to Step S82, and controller 16 is continuously in the sleep state. On the other hand, if the predetermined time has elapsed according to the determination result in Step S83 (Step S83: Yes), controller starts the operation (Step S84). Then, controller 16 performs the transmitting and receiving process during the operation.

Upon starting, controller 16 measures the voltage of external terminal 17e (i.e., output voltage of main power supply 2) (Step S91), and determines whether or not the voltage measured is higher than or equal to the recovery voltage (Step S92). If the measured voltage is higher than or equal to the recovery voltage according to this determination result (Step S92: Yes), controller 16 starts measuring a duration of a state in which the voltage measured is higher than or equal to the recovery voltage (Step S93). Then, controller 16 determines whether or not the duration has reached the threshold time (e.g., 2 seconds) (Step S94). According to the determination result, if the duration has reached the threshed time (e.g., 2 seconds) (Step S94: Yes), controller 16 determines that main power supply 2 has recovered (Step S95). Then, the process proceeds to Step S10. On the other hand, if the duration has not reached the threshold time in Step S94 (Step 94: No), controller 16 determines that main power supply 2 has not recovered, and the process returns to Step S82.

If the voltage measured is not higher than or equal to the recovery voltage according to the determination result in Step S92 (Step S92: No), controller 16 determines whether or not measurement of the duration is in progress (Step S96). If the duration is not measured (Step S96: No) according to this determination result, the process returns to Step S82. If measurement of the duration is in progress (Step S96: Yes), controller 16 resets the duration (Step S97), and the process returns to Step S82.

In the description of the operation, Steps S81 to S84 correspond to Step S8 shown in FIG. 4, and Steps 91 to S96 correspond to Step S9 shown in FIG. 4.

### (1-6) Effects

Backup power supply system 1 according to the first exemplary embodiment includes voltage detection circuit 13, power storage unit 10, connection circuit 12, and controller 16. Voltage detection circuit 13 is configured to detect a failure of main power supply 2 that supplies electric power to load 3. Power storage unit 10 is a power storage unit for backup of main power supply 2. If voltage detection circuit 13 detects a failure of main power supply 2, connection circuit 12 is configured to connect power storage unit 10 to load 3 to supply electric power from power storage unit 10 to load 3. If voltage detection circuit 13 detects the failure of main power supply 2, controller 16 receives power supplied from power storage unit 10 to perform an intermittent operation in which the controller repeats starting and stopping alternately.

This configuration suppresses power consumption of controller 16 during main power supply 2 has a failure since controller 16 performs the intermittent operation during the failure of main power supply 2. Thus, consumption of electric power stored in power storage unit 10 can be suppressed during the failure of main power supply 2. As a result, a duration of supplying electric power from power storage unit 10 to load 3 (backup duration) is extended during the failure of main power supply 2.

### (1-7) Aspects Other Than First Exemplary Embodiment

A function similar to backup power supply system 1 according to the first exemplary embodiment may be performed by a power supply backup method, a computer program (program), a non-transitory storage medium in which the computer program is stored, or the like.

The power supply backup method according to an aspect includes a detection process, a connection process, and a control process. In the detection process, a failure of a power supply that supplies electric power to a load is detected. In the connection process, a power storage unit for backup of the power supply is connected to the load to supply electric power from the power storage unit to the load if the failure of the power supply is detected in the detection process. In the control process, if the failure of the power supply is detected in the detection process, a controller receiving power supply from the power storage unit performs an intermittent operation in which the controller repeats starting and stopping alternately.

A program according to one mode causes a computer system to execute the above power supply backup method.

The non-transitory storage medium according to an aspect mode temporarily stores the program causing a computer to execute the above power supply backup method.

### (1-8) Modified Examples

Modified examples of the first exemplary embodiment will be described.

### (1-8-1) Modified Example 1

The first exemplary embodiment exemplifies a case where a failure of main power supply 2 is detected separately by two elements: controller 16 and voltage detection circuit 13. However, backup power supply system 1 may include only one of the failure determination process by controller 16 and voltage detection circuit 13 to detect a failure of main power supply 2 by only one element. If a failure of main power supply 2 is detected only by voltage detection circuit 13, a detection result of voltage detection circuit 13 is output to controller 16. Then, according to the detection result of voltage detection circuit 13, controller 16 determines whether or not main power supply 2 has a failure.

### (1-8-2) Modified Example 2

The first exemplary embodiment exemplifies a case where backup power supply system 1 is installed to a vehicle (e.g., automobile). However, backup power supply system 1 may be installed to movable objects (e.g., ship and airplane) other than the vehicle.

### (2) SECOND EXEMPLARY EMBODIMENT

In accordance with the first exemplary embodiment, controller 16 is configured to autonomously perform the intermittent operation if a failure of main power supply 2 is detected. In contrast, in accordance with a second exemplary embodiment, controller 16B is configured to perform the intermittent operation according to information received from brake system 3 if a failure of main power supply 2 is detected (i.e., performing the intermittent operation under the control by brake system 3).

The second exemplary embodiment will be detailed below. In the description a description of part same as the first exemplary embodiment is omitted, and only a part that differs from the first exemplary embodiment may be described.

### (2-1) Configuration

As illustrated in FIG. 1, backup power supply system 1 according to the second exemplary embodiment has a configuration similar to backup power supply system 1 according to the first exemplary embodiment except for an operation of controller 16B. In other words, the configuration of backup power supply system 1 according to the second exemplary embodiment is identical to the configuration of backup power supply system 1 according to the first exemplary embodiment.

Controller 16B of backup power supply system 1 according to the second exemplary embodiment performs the intermittent operation according to information (first information) received from controller 33 through communication with controller 33 of brake system 3 if a failure of main power supply 2 is detected. Then, if the failure of main power supply 2 is detected, controller 16B transmits, to controller 33 of brake system 3, information (second information) notifying detection of the failure of main power supply 2 from external terminal 17b.

If controller 33 of brake system 3 receives the second information from controller 16B, controller 33 transmits the first information to controller 16B via external terminal 34c. The first information is information on a communication interval of communication between controller 33 of brake system 3 and controller 16B.

Controller 33 of brake system 3 is configured to change the communication interval of communication with controller 16B. If controller 33 receives the second information from controller 16B of backup power supply system 1 (i.e., if a failure of main power supply 2 is detected), controller 33 changes the communication interval of communication with controller 16B. In other words, controller 33 changes the communication interval of communication with controller 16B to a second communication interval (e.g., 1 sec) different from a first communication interval (e.g., 20 msec) of the communication if no failure of main power supply 2 is detected. For example, if no failure of main power supply 2 is detected, controller 33 controls the communication interval to 20 msec. If a failure of main power supply 2 is detected, controller 33 controls the communication interval to allow the communication interval to be 1 second. In other words, controller 33 sends the first information to controller 16B by changing the communication interval from 20 msec to 1 second.

Controller 16B receives the first information from controller 33 by detecting that the communication interval of communication with controller 33 has been changed from the first communication interval (e.g., 20 msec) to the second communication interval (e.g., 1 second). Upon receiving the first information from controller 33, controller 16B performs the intermittent operation. In other words, if controller 16B detects that the communication interval has been changed from the first communication interval (e.g., 20 msec) to the second communication interval (e.g., 1 second), controller 16B regards the detection as receiving the first information from controller 33, and performs the intermittent operation.

Then, if controller 16B detects recovery of main power supply 2 or detects that the communication interval of communication with controller 33 has returned to the original communication interval (i.e., communication interval if no failure of main power supply 2 is detected), controller 16B ends the intermittent operation and switches to the normal operation.

As described above, in accordance with the second exemplary embodiment, controller 16B performs the intermittent operation at receiving the first information transmitted from controller 33 of brake system 3 (i.e., control by controller 33) and does not autonomously perform the intermittent operation if a failure of main power supply 2 is detected. Controller 33 detects that main power supply 2 has a failure by receiving the power supply start signal from controller 16B.

### (2-2) Operation

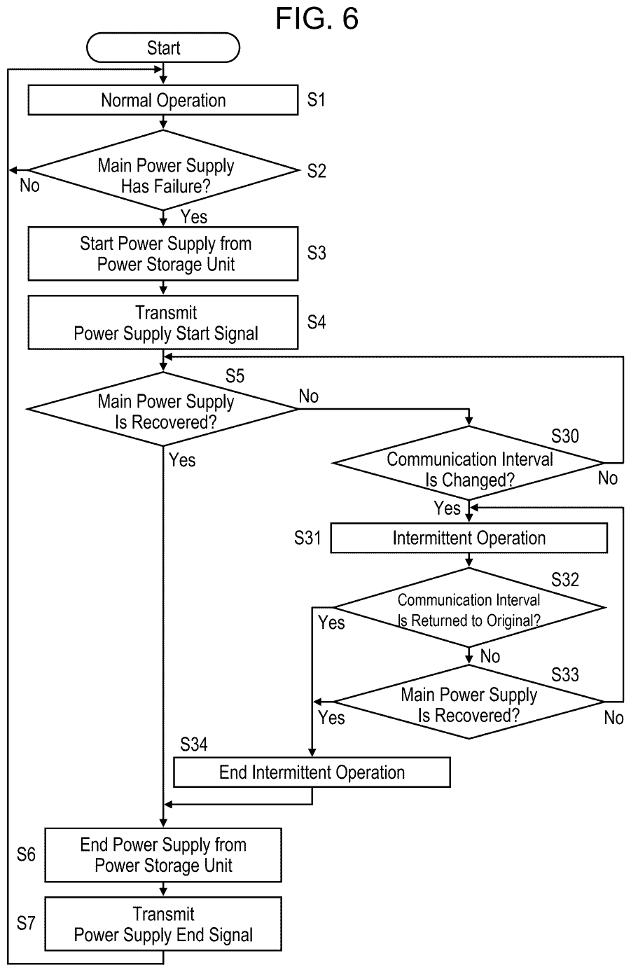

The operation of backup power supply system 1 according to the second exemplary embodiment will be described with reference to FIG. 6.

Steps S8 to S10 in FIG. 4 are replaced with Steps S30 to S34 in FIG. 6. In other words, Steps S1 to S7 in FIG. 6 are identical to Steps S1 to S7 in FIG. 4, and thus the description of these steps will be omitted. The description is focused on Steps S30 to S34 in FIG. 6.

In accordance with the second exemplary embodiment, controller 16B transmits the power supply start signal to controller 33 in Step S4, thereby allowing controller 33 to detect main power supply 2 has a failure. Then, if main power supply 2 has not recovered according to a determination result in Step S5 (Step 5: No), controller 16B determines whether or not the communication interval of communication with controller 33 has been changed (Step S30). According to this determination result, if the communication interval has been changed (Step S30: Yes), controller 16B regards the detection of change as reception of the first information from controller 33, and performs the intermittent operation (Step S31).

Then, controller 16B determines whether or not the communication interval has returned to the original communication interval (Step S32). According to this determination result, if the communication interval has returned to the original communication interval (Step S32: Yes), controller 16 ends the intermittent operation (Step S34). Then, the process proceeds to Step S6.

On the other hand, according to the determination result in Step S32, if the communication interval has not returned to the original communication interval (Step S32: No), controller 16 determines whether or not main power supply 2 has recovered (Step S33). According to this determination result, if main power supply 2 has recovered (Step S33: Yes), controller 16 ends the intermittent operation (Step S34). Then, the process proceeds to Step S6. On the other hand, according to the determination result in Step S33, if main power supply 2 has not recovered (Step S33: No), the process returns to Step S31.

The order of Step S32 and Step S33 may be replaced.

### (2-3) Major Effects

According to the second exemplary embodiment, controller 16B performs the intermittent operation according to the first information received from brake system 3, and brake system 3 thus provides a trigger (first information) to controller 16B to perform the intermittent operation.

If a failure of main power supply 2 is detected, the second information notifying the failure in main power supply 2 is transmitted from controller 16B to brake system 3. If brake system 3 receives the second information, brake system 3 transmits the first information to controller 16B. Therefore, brake system 3 does not necessarily include a detector configured to detect a failure of main power supply 2, and is configured to detect a failure of main power supply 2 by receiving the second information from controller 16B. The first information is information on the communication interval of communication between brake system 3 and controller 16B. Controller 16B performs the intermittent operation if the communication interval is changed to a communication interval different from the communication interval if main power supply 2 does not have a failure. Thus, brake system 3 allows controller 16B to perform the intermittent operation by simple processes of changing the communication interval of communication with controller 16B.

### (2-4) Modified Example

A modified example of the second exemplary embodiment will be described below.

The second exemplary embodiment exemplifies a case where the first information is information of the communication interval of communication between brake system 3 and controller 16B. However, the first information may be a start signal for starting controller 16B. In this case, controller 16B performs the intermittent operation upon receiving the start signal from controller 33 of brake system 3. Controller 33 of brake system 3 may transmit the start signal to controller 16B only at starting the intermittent operation, and controller 16B may autonomously perform the intermittent operation after starting the intermittent operation. Alternatively, controller 33 of brake system 3 may transmit the start signal to controller 16 every time starting the intermittent operation to start controller 16B.

### (3) THIRD EXEMPLARY EMBODIMENT

In accordance with the first exemplary embodiment, controller 16 continuously performs the intermittent operation if a failure of main power supply 2 is detected. In contrast, in accordance with a third exemplary embodiment, controller 16C performs the intermittent operation if a failure is detected in the main power supply 2 and further, if power storage unit 10 is not fully charged, a temperature of power storage unit 10 is less than a threshold temperature, or power storage unit 10 deteriorates.

The third exemplary embodiment will be detailed below. In the following description, the description of part same as the first exemplary embodiment is omitted, and the description is focused on part different from the first exemplary embodiment.

### (3-1) Configuration

As illustrated in FIG. 1, backup power supply system 1 according to the third exemplary embodiment has a configuration similar to that of backup power supply system 1 according to the first exemplary embodiment except for the operation of controller 16C. In other words, the configuration of backup power supply system 1 according to the third exemplary embodiment is the same as the configuration of backup power supply system 1 according to the first exemplary embodiment.

Controller 16C of backup power supply system 1 according to the third exemplary embodiment determines, according to an output voltage of power storage unit 10, whether or not power storage unit 10 is fully charged (full-charge determination).

Controller 16C determines whether or not the temperature of power storage unit 10 is lower than a threshold temperature (temperature determination) based on a measurement result of temperature measurement unit 15 (i.e., temperature of power storage unit 10).

Controller 16C determines whether or not power storage unit 10 deteriorates (deterioration determination). More specifically, controller 16C controls a charge circuit to charge power storage unit 10 until the output voltage of power storage unit 10 reaches a predetermined voltage. Then, if the output voltage of power storage unit 10 reaches the predetermined voltage, controller 16C stops the charging and causes a predetermined constant current to flow in power storage unit 10. Then, controller 16C calculates a resistance of power storage unit 10 based on a voltage drop across power storage unit 10 due to the flowing current and a value of the predetermined constant current. Using a correspondence relationship (correspondence relationship between the resistance of power storage unit 10 and deterioration of power storage unit 10), controller 16C determines, based on the calculated resistance, whether or not power storage unit 10 deteriorates or not. A method of detecting deterioration of power storage unit 10 is not limited to the above method, and any detection method can be adopted.

If a failure of main power supply 2 is detected and further if power storage unit 10 is not fully charged, the temperature of power storage unit 10 is lower than the threshold temperature, or power storage unit deteriorates, based on a result of the above three determinations (full-charge determination, temperature determination, or deterioration determination), controller 16C autonomously, for example, performs the intermittent operation.

If main power supply 2 has recovered, controller 16C stops the intermittent operation and switches to the normal operation.

### (3-2) Operation

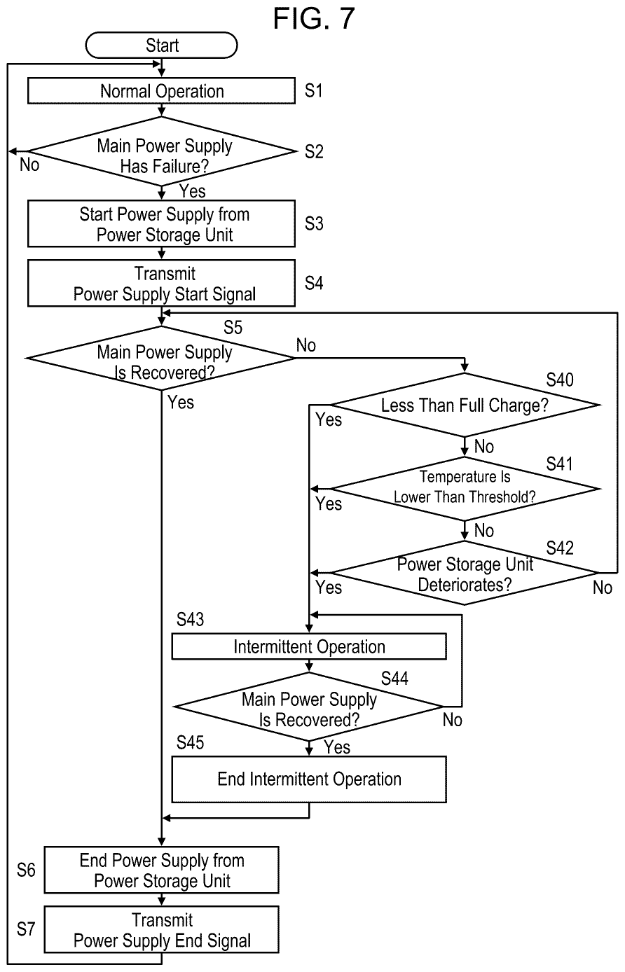

The operation of backup power supply system 1 according to the third exemplary embodiment will be described with reference to FIG. 7.

Steps S8 to S10 in FIG. 4 are replaced with Steps S40 to S45 in FIG. 7. In other words, Steps S1 to S7 in FIG. 7 are identical to Steps S1 to S7 in FIG. 4. The description of these steps will be omitted, and the description will be focused on Steps S40 to S45 in FIG. 7.

If main power supply 2 has not recovered based on the determination result in Step S5 (Step S5: No), controller 16C further determines whether or not power storage unit 10 is charged less than full charge (Step S40). If power storage unit 10 is charged less than full charge based on this determination result (Step S40: Yes), controller 16C performs the intermittent operation, for example, autonomously (Step S43). If power storage unit 10 is fully charged based on the determination result in Step S40 (Step S40: No), controller 16C further determines whether or not the temperature (temperature of power storage unit 10) measured by temperature measurement unit 15 is lower than the threshold temperature (Step S41). If the measured temperature is lower than the threshold temperature based on this determination result (Step S41: Yes), controller 16C performs the intermittent operation, for example, autonomously (Step S43). If the measured temperature is not lower than the threshold temperature based on the determination result in Step S41 (Step S41: No), controller 16C further determines whether or not power storage unit 10 deteriorates (Step S42). If power storage unit 10 deteriorates based on this determination result (Step S42: Yes), controller 16C performs the intermittent operation, for example, autonomously (Step S43). If power storage unit 10 does not deteriorate based on the determination result in Step S42 (Step S43: No), the process returns to Step S5.

After Step S43, controller 16C determines whether or not main power supply 2 has recovered (Step S44). If main power supply 2 has not yet recovered based on this determination result (Step S44: No), the process returns to Step S43. On the other hand, if main power supply 2 has recovered based on the determination result in Step S44 (Step S44: yes), controller 16C ends the intermittent operation (Step S45). Then, the process proceeds to Step S6.

### (3-3) Major Effects

In accordance with the third exemplary embodiment, controller 16C performs the intermittent operation if a failure of main power supply 2 is detected and further if power storage unit 10 is not fully charged, the temperature of power storage unit 10 is less than the threshold temperature, or power storage unit 10 deteriorates. This configuration extends the backup duration.

### (3-4) Modified Example

The third exemplary embodiment exemplifies a case where a determination is made in combination of the determination of whether or not power storage unit 10 is fully charged, determination of whether or not the temperature of power storage unit 10 is lower than the threshold temperature, and the determination of whether or not power storage unit 10 deteriorates. However, the order of these three determinations may be switched. Alternatively, only one or a combination of two of these three determinations may be performed. For example, if only the determination of whether or not power storage unit 10 is fully charged is performed in the above three determinations, controller 16C may perform the intermittent operation only if power storage unit 10 is not fully charged in addition to a failure of main power supply 2.

### (4) FOURTH EXEMPLARY EMBODIMENT

### (4-1) Configuration

A fourth exemplary embodiment is an exemplary embodiment combining the second exemplary embodiment and the third exemplary embodiment.

As illustrated in FIG. 1, a configuration of backup power supply system 1 according to the fourth exemplary embodiment is identical to the configuration of backup power supply system 1 according to the first exemplary embodiment. Controller 16D of backup power supply system 1 according to the fourth exemplary embodiment is configured to perform a process combining controller 16B of backup power supply system according to the second exemplary embodiment and controller 16C of backup power supply system 1 according to the third exemplary embodiment.

### (4-2) Operation

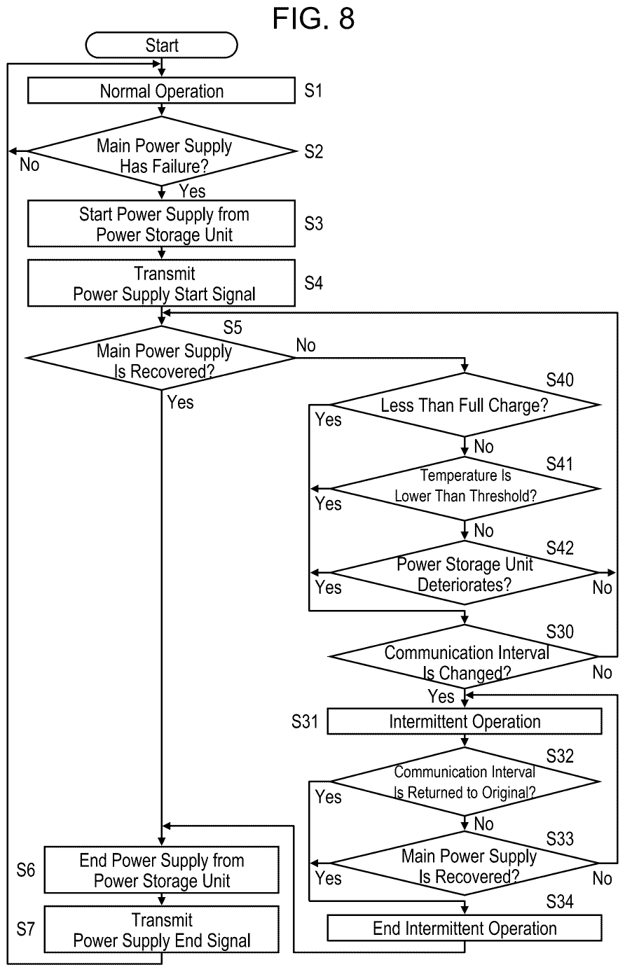

The operation of backup power supply system 1 according to the fourth exemplary embodiment will be described with reference to FIG. 8. The operation of backup power supply system 1 according to the fourth exemplary embodiment is the operation combining the operation of backup power supply system 1 according to the second exemplary embodiment and the operation of backup power supply system 1 according to the third exemplary embodiment.

Steps S1 to S7 and Steps S40 to S42 in FIG. 8 are identical to Steps S1 to S7 and Steps S40 to S43 in FIG. 7. Steps S30 to S34 in FIG. 8 are identical to Steps S30 to S34 in FIG. 6. Therefore, details of the operation illustrated in FIG. 8 will be omitted. Step S40 in FIG. 8 is different from Step S40 in FIG. 7 in that, if power storage unit 10 is not fully charged based on a determination result in Step S40 (Step S40: Yes), the process proceeds to Step S30.

### (4-3) Modified Example

The first to fourth exemplary embodiments may be combined with one another.

### (5) ASPECTS

According to the above exemplary embodiments and modified examples, the present disclosure may include the following aspects.

A backup power supply system (1) according to a first aspect includes a detector (13, 16, 16B, 16C, 16D), a power storage unit (10), a connection circuit (12), and a controller (16, 16B, 16C, 16D). The detector (13, 16, 16B, 16C, 16D) detects a failure of a power supply (2) that supplies electric power to a load (3). The power storage unit (10) is a power storage unit for backup of the power supply (2). If the detector (13, 16, 16B, 16C, 16D) detects a failure of the power supply (2), the connection circuit (12) is configured to connect the power storage unit (10) to the load (3) to supply electric power from the power storage unit (10) to the load (3). If the detector (13, 16, 16B, 16C, 16D) detects a failure of the power supply (2), the controller (16, 16B, 16C, 16D) is configured to receive power supply from the power storage unit (10), to perform an intermittent operation in which the controller repeats starting and stopping alternately, and to control connection circuit (12).

In this configuration, the controller (16) performs the intermittent operation when the power supply (2) has a failure, and suppresses power consumed by the controller (16, 16B, 16C, 16D) during the failure of the power supply (2). Thus, consumption of electric power stored in the power storage unit (10) is reduced during a failure of the power supply unit (2). As a result, the duration of supplying electric power (backup duration) from the power storage unit (10) to load (3) is extended during the failure of the power supply (2).

According to a second aspect of the backup power supply system (1), the controller (16, 16B, 16C, 16D) in the first aspect is configured to measure a voltage of power supply (2) at the start of the controller (16, 16B, 16C, 16D) in the intermittent operation. If the measured voltage is higher than or equal to a recovery voltage, the controller (16, 16B, 16C, 16D) is configured to determine whether or not a state that the voltage is higher than or equal to the recovery voltage continues for a threshold duration. If determining that the state continues for the threshold duration, the controller (16, 16B, 16C, 16D) switches from the intermittent operation to a normal operation. When the state is determined not to continue for the threshold duration, controller (16, 16B, 16C, 16D) continues the intermittent operation. When the voltage is less than the recovery voltage, controller (16, 16B, 16C, 16D) continues the intermittent operation.

This configuration allows the controller (16, 16B, 16C, 16D) to continue the intermittent operation or to switch to the normal operation according to recovery of the power supply (2). Since the operation is switched when recovery of the power supply (2) continues for a predetermined duration, the operation is switched if power supply (2) is stably recovered.

According to a third aspect of the backup power supply system (1), in the first or second aspect, the controller (16B, 16D) is configured to communicate with the load (3). The controller (16B, 16D) is configured to perform the intermittent operation based on first information received from the load (3).

This configuration allows the controller (16B) to perform the intermittent operation according to a trigger (the first information) from the load (3).

According to a fourth aspect of the backup power supply system (1), in the third aspect, the controller (16B, 16D) is configured to transmit, to the load (3), second information notifying a failure of the power supply (2) if the detector (13, 16B, 16D) detects the failure of the power supply (2). If the load (3) receives the second information, the load (3) transmits the first information to the controller (16B, 16D).

This configuration allows the load (3) to detect a failure of the power supply (2), by receiving the second information from controller (16B, 16D) without a detector for detecting a failure of the power supply (2).

According to a fifth aspect of the backup power supply system (1), in the third or fourth aspect, the first information is information on a communication interval of communication between the load (3) and the controller (16B, 16D). If the controller (16B, 16D) detects that the communication interval is changed to a first communication interval different from the first communication interval for a case where the power supply (2) does not have a failure, the controller (16B, 16D) is configured to perform the intermittent operation.

With this configuration, the load (3) is configured to allow the controller (16B, 16D) to perform the intermittent operation simply by changing the communication interval of communication with the controller (16B, 16D).

According to a sixth aspect of backup power supply system (1), in the first to fifth aspects, the controller (16, 16B) is configured to autonomously perform the intermittent operation if a failure of the power supply (2) is detected.

With this configuration, the controller (16, 1B) is configured to perform the intermittent operation autonomously (without being dependent on an external signal).

According to a seventh aspect of backup power supply system (1), in one of the first to sixth aspects, the controller (16, 16B) is configured to continuously perform the intermittent operation from detection of a failure of the power supply (2) until recovery of the power supply (2).

With this configuration, the controller (16, 16B) always suppresses power consumption during the failure of the power supply (2).

According to an eighth aspect of backup power supply system (1), in one of the first to sixth aspects, the controller (16C, 16D) is configured to perform the intermittent operation if a failure of the power supply (2) is detected and also the power storage unit (10) is not fully charged.

With this configuration, the controller (16C, 16D) suppresses power consumption if power storage unit (10) is not fully charged at a failure of the power supply (2). Thus, the backup duration is extended if power storage unit (10) is not fully charged at a failure of the power supply (2).

A ninth aspect of the backup power supply system (1), in one of the first to sixth aspects, further includes a temperature measurement unit (15) configured to measure a temperature of the power storage unit (10). If a failure of the power supply (2) is detected and the temperature measured by temperature measurement unit (15 is lower than a threshold, the controller (16C, 16D) is configured to perform the intermittent operation.

With this configuration, power consumption of the controller (16C, 16D) is suppressed if the temperature of the power storage unit (10) is lower than the threshold at a failure of the power supply (2). The capacity of the power storage unit (10) decreases when the temperature of the power storage unit (10) becomes less than the threshold. Therefore, the above configuration extends the backup duration even when the capacity of the power storage unit (10) is decreased due to a low temperature of the power storage unit (10) at a failure of the power supply (2).

According to a tenth aspect of the backup power supply system (1), in one of the first to sixth aspects, the controller (16C, 16D) is configured to detect deterioration of the power storage unit (10). If a failure of power supply (1) is detected and also deterioration of the power storage unit (10) is detected, the controller (16C, 16D) is configured to perform the intermittent operation.

This configuration suppresses power consumption of the controller (16C, 16D) if deterioration of the power storage unit (10) is detected at a failure of the power supply (2). The capacity of the power storage unit (10) decreases when power storage unit (10) deteriorates. With the above configuration, the backup duration is extended even if the capacity of power storage unit (10) is decreased due to deterioration of the power storage unit (10) at a failure of the power supply (2).

A movable body (4) according to an eleventh aspect includes the backup power supply system (1) according to one of the first to tenth aspects, the load (3), and a main body (41). The main body (41) has the backup power supply system (1) and the load (3) installed thereto.

With this configuration, the movable body exhibits the above effects of the backup power supply system (1).

A power supply backup method according to a twelfth aspect includes a detection process, a connection process, and a control process. In the detection process, a failure of the power supply (2) that supplies electric power to a load (3) is detected. In the connection process, the power storage unit (10) for backup of power storage unit (2) is connected to the load (3) to supply electric power from the power storage unit (10) to the load (3) if a failure of the power supply (2) is detected in the detection process. In the control process, the controller (16, 16B, 16C, 16D) receiving power supply from the power storage unit (10) performs an intermittent operation in which the controller repeats starting and stopping alternately if a failure of power supply (2) is detected in the detection process.

With this configuration, since the controller (16, 16B, 16C, 16D) performs the intermittent operation at a failure of the power supply (2), power consumption of the controller (16, 16B, 16C, 16D) at a failure of the power supply (2) is reduced. Thus, consumption of electric power stored in the power storage unit (10) is suppressed at a failure of the power supply (2). As a result, a duration of supplying electric power from the power storage unit (10) to the load (3) (backup duration) is extended at a failure of the power supply (2).

A program according to a thirteenth aspect causes a computer system to execute the power supply backup method according to the twelfth aspect.

This configuration provides a program storing the above-described backup power supply system (1).

In a power supply backup method according to a fourteenth aspect, a failure of the power supply (2) that supplies electric power to the load (3) is detected. After a failure of the power supply (2) is detected, the power storage unit (10) is connected to the load (3) to supply electric power from the power storage unit (10) to the load (3). After a failure of the power supply (2) is detected, electric power from the power storage unit (10) is supplied to the controller to cause the controller (16, 16B, 16C, 16D) to perform the intermittent operation in which the controller repeats starting and stopping alternately.

With this configuration, since the controller (16, 16B, 16C, 16D) performs the intermittent operation at a failure of the power supply (2), power consumption of the controller (16, 16B, 16C, 16D) is reduced at a failure of the power supply (2). Thus, consumption of electric power stored in the power storage unit (10) is reduced at a failure of the power supply (2). As a result, time supplying electric power from the power storage unit (10) to the load (3) (backup duration) is extended at a failure of the power supply (2).

### REFERENCE MARKS IN DRAWINGS

1 backup power supply system
2 main power supply (power supply)
4 vehicle (movable body)
41 vehicle body (main body)
10 power storage unit
12 connection circuit
13 voltage detection circuit (detector)
16, 16B, 16C, 16D controller (detector)

1. A backup power supply system comprising:
a detector configured to detect a failure of a power supply that supplies electric power to a load;
a power storage unit;
a connection circuit configured to connect the power storage unit to the load and supply electric power from the power storage unit to the load if the detector detects the failure of the power supply; and
a controller configured to control the connection circuit, wherein
the controller is configured to, if the detector detects the failure of the power supply, receive the electric power supplied from the power storage unit and performs an intermittent operation in which the controller repeats starting and stopping alternately.

2. The backup power supply system according to claim 1, wherein the controller is configured to:
measure a voltage of the power supply while performing the intermittent operation;
if the voltage measured is higher than or equal to a recovery voltage, determine whether or not a state in which the measured voltage is higher than or equal to the recovery voltage continues for a threshold duration;
switch the intermittent operation to a normal operation if determining the state continues for the threshold duration:
continue the intermittent operation if determining the state does not continue for the threshold duration; and
continue the intermittent operation if the voltage is lower less than the recovery voltage.

3. The backup power supply system according to claim 1, wherein
the controller is configured to communicate with the load, and
the controller is configured to perform the intermittent operation based on first information received from the load.

4. The backup power supply system according to claim 3, wherein
the controller is configured to transmit, to the load, second information notifying an occurrence of the failure of the power supply if the detector detects the failure of the power supply, and
the load is configured to transmit the first information to the controller if the load receives the second information.

5. The backup power supply system according to claim 3, wherein
the first information is information on a communication interval of communication between the load and the controller, and
the controller is configured to perform the intermittent operation if detecting a change of the communication interval to a second communication interval, the second communication interval being different from a first communication interval of the communication when the power supply does not have a failure.

6. The backup power supply system according to claim 1, wherein the controller is configured to autonomously perform the intermittent operation if detecting the failure of the power supply.

7. The backup power supply system according to claim 1, wherein the controller is configured to continuously perform the intermittent operation for a time from detection of the failure of the power supply to recovery of the power supply.

8. The backup power supply system according to claim 1, wherein the controller is configured to perform the intermittent operation if detecting the failure of the power supply and the power storage unit is not fully charged.

9. The backup power supply system according to claim 1, further comprising
a temperature measurement unit configured to measure a temperature of the power storage unit, wherein
the controller is configured to perform the intermittent operation if detecting the failure of the power supply and the temperature measured by the temperature measurement unit is lower than a threshold.

10. The backup power supply system according to claim 1, wherein
the controller is configured to detect deterioration of the power storage unit, and
the controller is configured to perform the intermittent operation if detecting the failure of the power supply and the deterioration of the power storage unit.

11. A movable body comprising:
the backup power supply system according to claim 1;
the load; and
a main body including the backup power supply system and the load.

12. A power supply backup method comprising:
detecting a failure of a power supply that supplies electric power to a load;
supplying electric power from a power storage unit to the load by connecting the power storage unit to the load if detecting the failure of the power supply; and
causing a controller to receive the electric power supplied from the power storage unit to perform an intermittent operation in which the controller repeats starting and stopping alternately if detecting the failure of the power supply.

13. A program causing a computer system to execute the power supply backup method according to claim 12.

14. A power supply backup method comprising:
detecting a failure of a power supply that supplies electric power to a load;
supplying electric power from a power storage unit to the load by connecting the power storage unit to the load after detecting the failure of the power supply; and
causing a controller to perform an intermittent operation in which the controller repeats starting and stopping alternately by supplying the electric power from the power storage unit to the controller after detecting the failure of the power supply.
